(19) United States
(12) Patent Application Publication
(10) Pub. No.: US 2006/0234069 A1
(43) Pub. Date: Oct. 19, 2006

(54) Method for forming shoot houses

(76) Inventors: H. Addison Sovine, Orem, UT (US); Kyle E. Bateman, Provo, UT (US); David Bassett, Provo, UT (US); James Sovine, Orem, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/397,940

(22) Filed: Apr. 3, 2006

Related U.S. Application Data
(60) Provisional application No. 60/668,708, filed on Apr. 5, 2005.

(51) Int. Cl. B32B 15/04

(52) U.S. Cl. 428/457; 428/911

(57) ABSTRACT

A modular ballistic ceiling allows increased flexibility in building and reassembling shoot houses. Shoot houses may be built with multiple levels which are completely modular.

### RELATED APPLICATIONS

The present application claims the benefit of U.S. Provisional Application No. 60/668,708, filed Apr. 5, 2005, which is incorporated herein in its entirety.

### BACKGROUND OF THE INVENTION

1. The Field of the Invention

The present invention relates to shoot houses and ballistic training. More specifically, the present invention relates to a method for forming shoot houses with modular ballistic walls and/or a modular ballistic ceiling.

2. State of the Art

In conducting training for individuals such as police officers, military personnel, etc., it is desirable to duplicate the conditions which the individual may encounter while working. Thus, training should simulate real life scenarios, with the goal of making the training as realistic as is practical.

Accordingly, it is common to form shoot houses for training purposes. A shoot house is a building which is formed with bullet proof walls such that police officers, military personnel, or the like may train in the building under line of fire conditions. The training may include breaking into a building, sweeping the area to make it secure, finding objects in the building, etc. and targets may be used in the building to represent the threats encountered in the course of duty.

It is desirable to make such shoot houses modular so that they may be constructed in a variety of configurations, and even partially or completely disassembled to move the shoot house or reconstruct it in a different configuration. A modular shoot house is thus more useful as it may be used to train for a variety of different situations.

For similar reasons, it is desirable to form a shoot house which has two or more levels so that the shoot house resembles a building with multiple floors, such as a two story building. It would also be desirable if the shoot house remains modular even with multiple floor levels.

In making shoot houses with multiple levels, individuals have formed a separately supported concrete ceiling over the first level which also forms the floor of the second level. This, however, is a permanent structure that can not be changed without significant difficulty. The concrete ceiling and floor is typically formed on top of permanent walls or pillars and thus may not be changed. The walls, pillars, stair openings, etc. often are not in the proper location for a desired shoot house arrangement. Additionally, if the shoot house is to be moved the concrete ceiling and support structure must either be left behind or demolished at a sizable expense.

Additionally, it has been known to form small catwalks above a shoot house to allow a supervisor to oversee the training occurring in the shoot house. They do not, however, prevent bullets from exiting the shoot house and would not support a second floor of a shoot house. As such they do not present a safe and effective way of forming a two story shoot house. It has also been known to suspend bullet proof ceiling baffles above a shoot house. The baffles may be suspended in an arc above the shoot house, forming a canopy above the shoot house to prevent stray bullets from exiting the training area. The baffles do not form a ceiling, however, being merely suspended from a structure above the shoot house.

There is thus a need for a modular ceiling which may be easily disassembled and which may be easily rearranged when changing the configuration of the shoot house.

### SUMMARY OF THE INVENTION

It is an object of the present invention to provide an improved method for forming shoot houses. It is a further object of the present invention to provide a method for forming a modular ceiling which is bullet proof. It is a further object to provide a method of forming a modular shoot house having multiple levels.

According to some aspects of the present invention, a modular ceiling may be formed as part of a modular shoot house. The ceiling may thus be formed from standard sized steel panels. The ceiling may thus be rearranged easily when changing the configuration of the shoot house and is less expensive to manufacture. Replacement plates may be obtained or constructed with less machining required.

According to other aspects of the invention, the ceiling may be formed from standard sized bullet proof plate. The steel plate is then easier to replace and requires less machining of the hardened steel, which is difficult and may weaken the steel.

According to other aspects of the invention, the ceiling may be relatively inexpensive. Using standard sized steel panels for the ceiling reduces the machining required to produce the ceiling parts and makes the parts easier to replace. Additionally, parts which require more machining may be formed of a milder steel.

According to other aspects of the invention, the ceiling may be easily constructed. The ceiling may be assembled with readily available tools and without great difficulty. A modular ceiling made of standard pieces is relatively easy to construct.

According to yet another aspect of the invention, the ceiling may be easily configured to operate with a variety of different shoot house configurations. Because standard sized steel panels may be used in combination with standard joining and support pieces, the ceiling may easily be arranged in a number of configurations without the hassle of purchasing or acquiring many specialized pieces.

### BRIEF DESCRIPTION OF THE DRAWINGS

Various embodiments of the present invention are shown and described in reference to the numbered drawings wherein:

FIG. 1 shows a portion of a modular shoot house wall as is known in the prior art;

FIG. 2 shows a portion of a shoot house wall according to aspects of the present invention;

FIGS. 3a-3e show ceiling brackets according to aspects of the present invention;

FIGS. 4a and 4b show end views of a ceiling according to aspects of the present invention;

FIGS. 4c and 4d show details of a bullet proof plate according to the present invention;

FIG. 5 shows a side view of a ceiling according to aspects of the present invention;

FIG. 6a shows a side view of another ceiling according to the present invention;

FIG. 6b shows a side view of another ceiling according to the present invention;

FIG. 7 shows a side view of yet another ceiling according to the present invention;

FIGS. 8a-8f show end views of support members according to the present invention;

FIG. 9a shows a side view of a portion of a shoot house according to the present invention;

FIG. 9b shows a side view of a portion of a shoot house according to the present invention;

FIG. 10 shows a front view of first and second floor walls according to the present invention;

FIG. 11a shows a front view of a bracket of the present invention;

FIG. 11b shows a side view of the bracket of FIG. 11a;

FIG. 12a shows a front view of a bracket of the present invention;

FIG. 12b shows a side view of the bracket of FIG. 12a;

FIG. 13 shows a joint of a shoot house using the bracket of FIGS. 11a and 11b;

FIG. 14 shows a joint of a shoot house using the bracket of FIGS. 12a and 12b;

FIG. 15a shows a top view of a bracket of the present invention;

FIG. 15b shows a side view of the bracket of FIG. 15a;

FIG. 15c shows an end view of the bracket of FIG. 15a;

FIG. 16a shows a side view of a bracket of the present invention;

FIG. 16b shows a top view of the bracket of FIG. 16a;

FIG. 17 shows a joint of a shoot house using the bracket of FIGS. 16a and 16b; and

FIG. 18 shows a joint of a shoot house using the bracket of FIGS. 15a through 15c.

It will be appreciated that the drawings are illustrative and not limiting of the scope of the invention which is defined by the appended claims. The various embodiments shown accomplish various aspects and objects of the invention. It is further appreciated that it is not possible to show each structure and element of the invention in a single drawing, and as such multiple drawings are presented which each show aspects of the invention in greater detail. The invention thus encompasses all of the drawings.

### DETAILED DESCRIPTION

The drawings will now be discussed in reference to the numerals provided therein so as to enable one skilled in the art to practice the present invention. The drawings and descriptions are exemplary of various aspects of the invention and are not intended to narrow the scope of the appended claims.

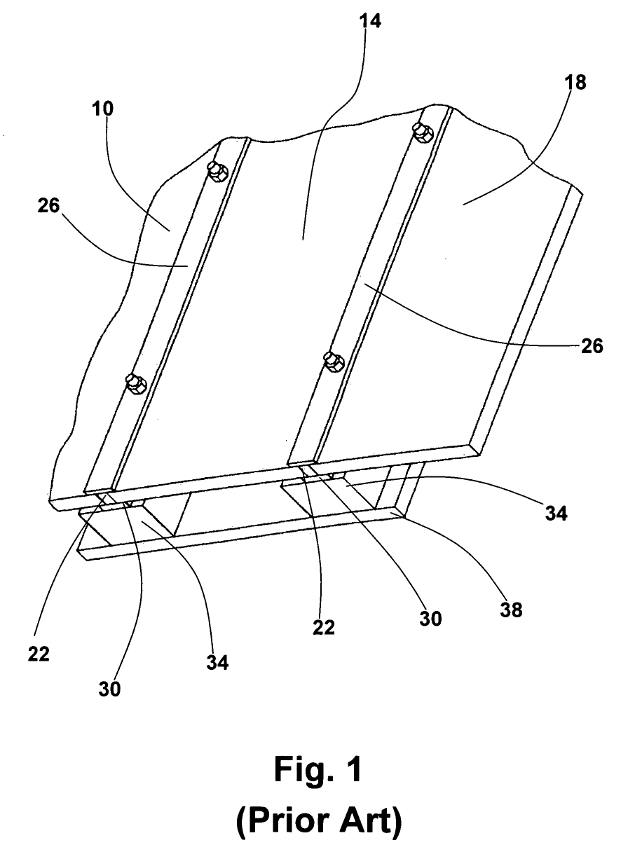

Turning to FIG. 1, a section of a modular shoot house wall as known in the prior art is shown. Modular shoot houses have been formed with bullet proof steel plate wall panels 10, 14, and 18. The joints 22 between the plates 10, 14, 18, may be covered with a backing strip of steel 26 and a facing strip of steel 30 which are bolted together to prevent bullets from passing through the joint.

Additionally, strips of wood 34 may be attached to the steel wall, with sheets of sheetrock or plywood 38 attached to the wood strips 34, forming a space to contain bullets and also making the surface of the wall look more similar to a conventional wall. Typically, a simple roof, such as a layer of corrugated metal or a tent like canopy, is placed over the shoot house to protect the shoot house from rain or the like if the shoot house is used in a rainy environment.

As mentioned previously, two level shoot houses have been formed by constructing sufficient support pillars or load bearing walls to support a concrete ceiling and then forming a shoot house under the structure. The lower level of the shoot house is built underneath the concrete, and an upper level is built above the concrete. As previously discussed, the concrete ceiling and supports can not be moved, and often do not integrate well into the shoot house. For example, a support column may extend into a room or may partially obstruct a hall.

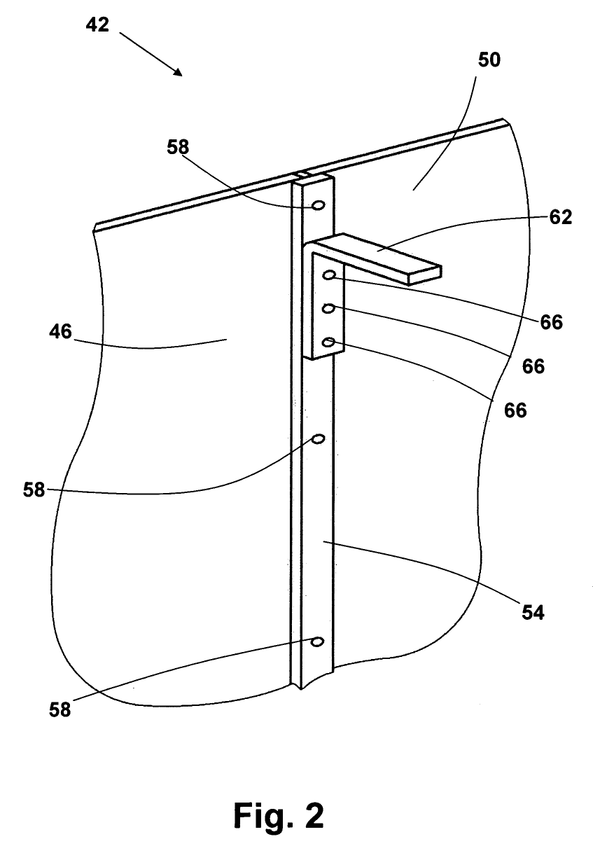

Turning to FIG. 2, a wall of a shoot house according to the present invention is shown. The wall, indicated generally at 42, is formed of panels of steel 46 and 50. The panels are placed adjacent each other and a facing strip 54 is placed over the joint. A backing member, such as a strip, washers, or the like (not shown), is placed across the back of the joint and the facing strip and backing member are bolted against the plates by bolts 58, clamping the facing strip and backing member against the plates and securely holding the wall together.

A bracket 62 is also attached to the wall 42. The bracket 62 may be attached with bolts 66, or it may be welded to the facing strip or otherwise attached to the facing strip, or formed integrally with the facing strip. The bracket 62 is designed to support the ceiling of the shoot house as will be discussed in the following figures. As the various ceiling pieces are assembled on top of the walls, the ceiling pieces brace the walls and strengthen the structure. It will be appreciated that using a number of bolts 66 not only strengthens the attachment between the wall 42 and the bracket 62, but also provides some flexibility in mounting the bracket. In addition to bolts 66, the bracket may simply be welded or otherwise attached to the facing strip 54 if so desired. For example, facing strips made for a multi-level shoot house may be constructed with brackets permanently attached, as nearly all facing strips can be used to support the ceiling structure. Likewise, the brackets can be formed integrally with the facing strips. It is appreciated that the wall shows in FIG. 2 may also include spacing strips such as wood strips disposed along and/or attached to the facing strips, and plywood sheet or other sheet attached to the spacing strip to form a bullet containment chamber similar to that of FIG. 1.

The structures shown and discussed relative to FIG. 2 are also encompassed in the other figures, as FIG. 2 shows only a portion of the invention.

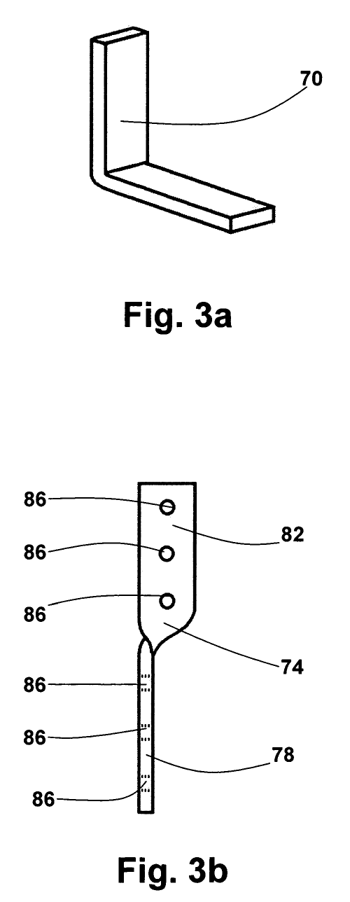

Turning to FIG. 3a through FIG. 3e, various brackets according to the present invention are shown. FIG. 3a shows a bracket 70 which is simply an L shaped bracket formed form a piece of steel. It will be appreciated that the bracket must both attach to the wall and support the ceiling, and that an L bracket provides the necessary surfaces. The bracket may be welded or otherwise attached to the walls and ceiling. Additionally, the bracket may be bolted to the walls and ceiling. In one embodiment, the bracket is bolted to the wall facing strips and the ceiling support members so that the facing strips form support columns integral to the shoot house. This leaves maximum flexibility in constructing a modular shoot house. Accordingly, the bracket may be provided with holes formed in the bracket for receiving such bolts.

FIG. 3b shows another bracket 74 which has been formed from a strip of steel which is twisted such that one end 78 may attach to the wall and the other end 82 may be attached to the side of a ceiling rail or support. Also, holes 86 have been formed in the bracket 74 so that the bracket may be easily attached to the wall and ceiling. As many holes as are necessary may be formed in the bracket. It will be appreciated that the bracket may be made sufficiently large to be strong enough to support the weight which will be placed on it. One of skill in the art will recognize that the bracket must be sufficiently large so as not to bend or otherwise deform under the weight of the ceiling. Additionally, the attachment means, such as the bolts, must be sufficiently strong to support the weight of the ceiling and any other shoot house structure on top of the ceiling. This may mean that a particular number of bolts must be used, depending on the shear strength of the bolts.

FIG. 3c shows another bracket according to the present invention. The bracket 90 has been formed from steel, and has an upper portion 94 which is attached to the wall. The lower portion 98 attaches to the ceiling members, and has two side arms 102 and 106 which have been bent to form a cradle. The lower portion 98 has been shaped to support a beam or channel which supports the ceiling panels. With the part of the bracket which attaches to the wall 94 being bent up above the part of the bracket which supports the ceiling 98, the upper portion 94 is protected from bullets by the ceiling. It will be appreciated that many different means may be used to attach the bracket to the wall and ceiling, with welding and bolting being the most common methods. In one embodiment, the bracket will be formed with holes similar to the brackets in FIGS. 3b and 3d, and that the various shoot house components such as the facing strips and ceiling support members will have corresponding holes formed therein to facilitate construction of the shoot house.

FIG. 3d shows a bracket 110 which is similar to the bracket of FIG. 3, except that the lower portion 114 is configured for attachment to a wall, and the upper portion 118 is shaped to support the ceiling. The upper portion has two tabs 122, 126 which are bent upwardly to form a cradle to receive a ceiling support member. The bracket 110 is shown with holes 130 to attach the bracket to the wall and ceiling. As many holes 130 as are needed may be formed so long as the bracket 110 is not weakened by the holes. It will be appreciated that while the lower portion 114 is more exposed to bullets than the upper portion 94 of the bracket of FIG. 3c, the bracket 110 of FIG. 3d may be easier to install.

FIG. 3e shows another bracket 134 according to the present invention. The bracket 134 may be formed from an L shaped piece of metal which has been bent twice into the shape shown. The bracket 134 is thus simple to form. A lower portion 138 is provided to attach the bracket to a wall, and an upper portion 142 is attached to the ceiling members. A tab 146 is bent as shown to further support the ceiling members. Holes 150 have been formed in the upper portion 142 of the bracket 134 to allow the ceiling members to be bolted to the bracket. Additionally, a number of holes 154 have been formed in the lower portion 138 of the bracket 134 for attachment to the walls of a shoot house. Having a number of holes 154 may allow the height of the bracket 134 relative to the wall to be adjusted if so desired, ensuring that the floor is level and in the correct position. Having a number of holes will also allow more bolts to be used to attach the bracket to the wall, providing a more secure attachment to the walls of the shoot house.

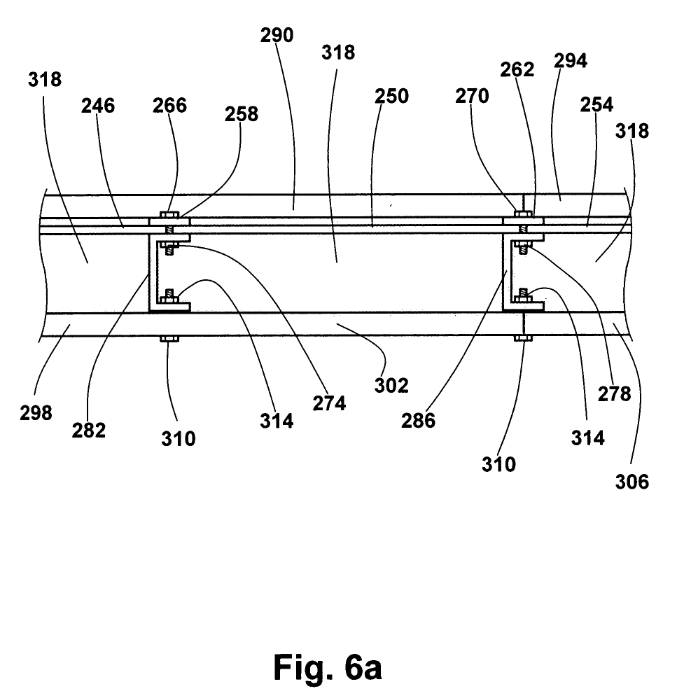

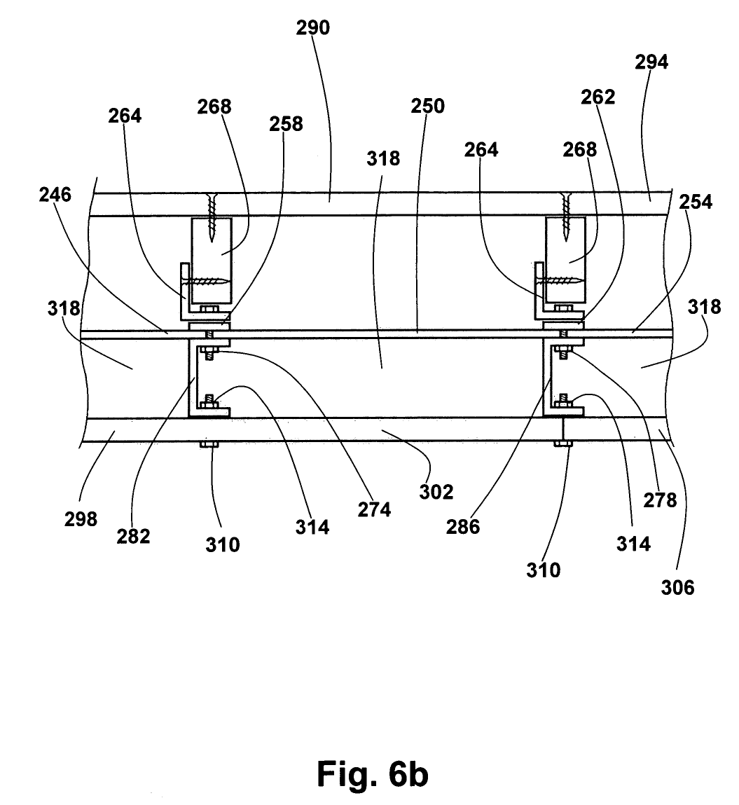

It is appreciated from FIGS. 3a-3e that many different bracket shapes and configurations are available which are suitable for attaching a ceiling member (typically a support beam type member) to a modular ballistic wall. The brackets of FIGS. 3a-3e are thus part of FIGS. 9a and 9b, and of the other figures. Many of the figures show only subassemblies or portions of the invention and are thus viewed in combination with the other figures to appreciate the entire invention.

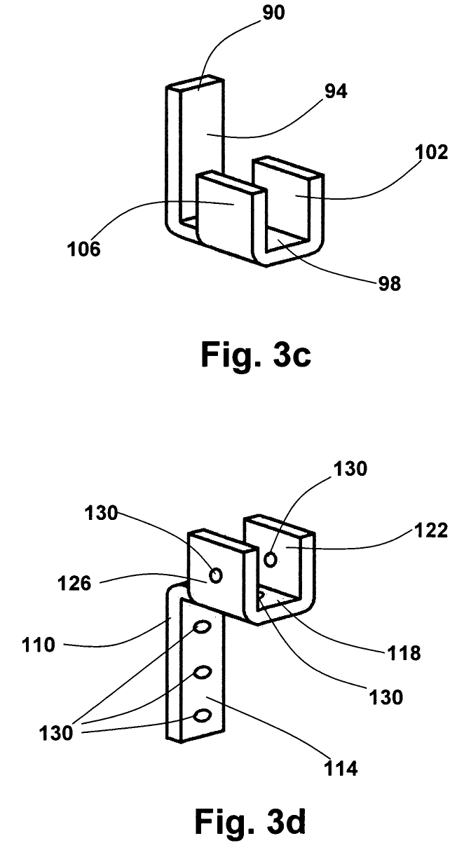

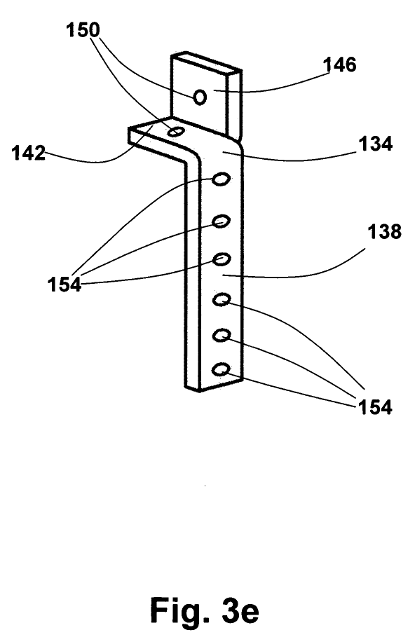

Turning to FIG. 4a, an end view of a ceiling of the present invention is shown. The ceiling may be formed of standard sized steel plates 158. Typically, the edges 162 of the plates 158 are placed adjacent one another forming a joint. The joint is covered with a facing strip 166 and a backing means or backing member 170, which may be a backing strip, a number of washers, or the like. The facing strip 166 and backing member 170 may be held together by an attachment means such as bolts 174 and nuts 178 which may extend between or through the plates. Alternative methods of fastening are available, such as threading the backing member, using rivets or screws or the like, but a nut and bolt are the most convenient.

The steel plate may be supported by various support members, such as channels 182. The support members may be sized and spaced according to the strength needed in the ceiling. The support members may typically be attached to the brackets which are attached to the walls. They will then serve to both support and strengthen the ceiling and brace the walls. It will be appreciated that many different shapes of support members may be used, including members with cross sections such as channels, boxes, I beams, C beams, etc. Additionally, many methods of attaching the steel plate 158 to the support members 182, such as welding, bolting, gluing, etc. The more preferred method of attaching the plate to the support members is bolting, as it leaves maximum flexibility in constructing and modifying the shoot house.

Turning now to FIG. 4b, another side view of a ceiling of the present invention is shown. The ceiling shown is similar to the ceiling of FIG. 4a, and is a functional equivalent of the ceiling of FIG. 4a. The ceiling includes steel plates 158 which are placed adjacent each other and joined with a facing strip 166 and backing means 170, which may be a backing strip, washers, etc. The edges 162 of the steel plates 158 have openings 164 formed therein to allow the bolts 174 to pass through the plates 158 to assemble the joint. It is appreciated that various methods of forming the joint are possible, including passing the bolts 174 between the plates or through the plates. What is important is forming a joint which is not easily penetrated by bullets, as is accomplished by securely fastening the facing strip 166 to the edges 162 of the plates 158.

Turning now to FIG. 4c, a perspective view of a part of a plate as may be used in forming walls or ceilings is shown. The plate 158 includes an opening 164 which a bolt may pass through. In the plate 158 shown, the opening 164 is a hole. FIG. 4d shows a similar portion of a plate 158 where the opening 164 is formed as a keyhole slot. Such a keyhole slot may be more easily formed by a plasma cutter, or other methods. It is thus appreciated that it is not critical precisely how a hole may be formed. Any of the joints between plates shown in the present invention may be formed as shown in FIGS. 4a-4d. For clarity, not every possible type of joint is shown with every possible wall or ceiling structure, or in combination with every possible shape of support beam.

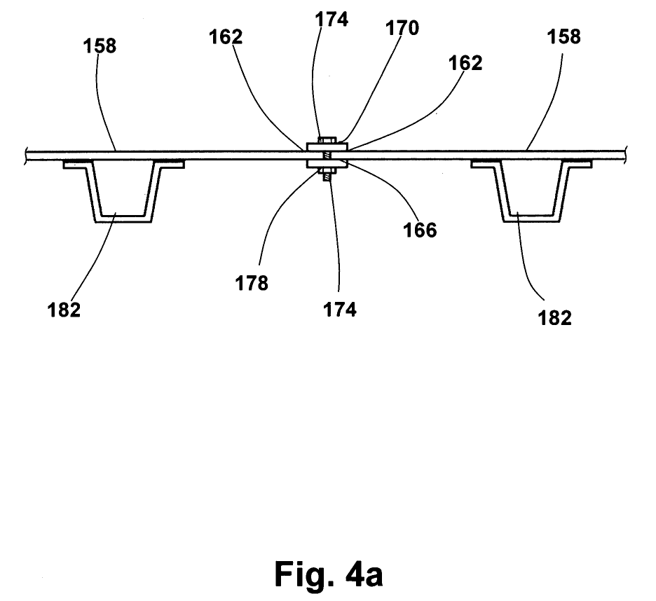

Turning to FIG. 5, another side view of a ceiling is shown. The ceiling is formed with steel plates 186, 190, and 194. The edges of the plates are placed together forming joints, indicated generally at 198 and 202. Here, support members 206 and 210 having C shaped cross sections have been used. An upper edge 214 and 218 of the members 206, 210 has been used as a facing strip to cover the joints 198, 202. Accordingly, the backing member 222 and 226 may be bolted to the support 206, 210 using bolts 230 and 234 and nuts 238 and 242. Using the support members to cover the joint simplifies the joint and makes it easier to manufacture and assemble.

It will be appreciated that a ceiling such as that of FIG. 5 may be assembled by attaching the support members 206, 210 to the brackets which have been attached to the tops of the walls, placing the steel panels 186, 190, 194 on top of the support members, placing backing members such as backing strips 222, 226 over the joint, and bolting the assembly together. The resulting structure may easily be made strong enough to support the weight of another floor of the shoot house and the individuals and equipment placed in the shoot house.

If necessary, additional support members may be placed between the joints to stiffen the ceiling and prevent the steel plate from bending under the weight which may be placed upon it. Such support member may be similar to the supports 206, 210, and may run parallel to or transverse to the support members 206, 210. Additionally, one will realize that many variations may be made without departing from the present invention, such as using washers instead of backing strips, or using a fastener other than bolts. The present invention encompasses such variations.

In addition to ease of assembly, the ceiling may be assembled in a variety of configurations. If the ceiling is assembled with standard sized steel panels, each panel may be placed in any location in the ceiling whereas specially shaped panels must be placed in particular locations in a ceiling. Additionally, the steel panels used may be the same size as the walls of the shoot house. For example, if four foot by eight foot panels are used, the walls of the first level of the shoot house would form joints which are spaced apart every four feet and walls would be spaced apart in four foot increments. All of the joints would be evenly spaced in four foot increments.

Accordingly, ceiling plates which are also four foot by eight foot panels would align with the wall panels such that the ceiling joints and edges would align with the joints of the wall panels. Thus, it is easy to locate the support members and construct the ceiling. Accordingly, support members may be placed in a parallel arrangement between the joints of the wall panels, stretching across the shoot house, and the ceiling panels would line up properly on the support members. Additionally, the support members would only need be provided in four foot increments, and the maximum length of the members needed would be determined by the width of the rooms. Many configurations of shoot houses could be built by having four, eight, and twelve foot support members. If the members all stretch the same direction across the shoot house, rooms with a side longer than twelve feet such as hallways may be oriented perpendicular to the support members.

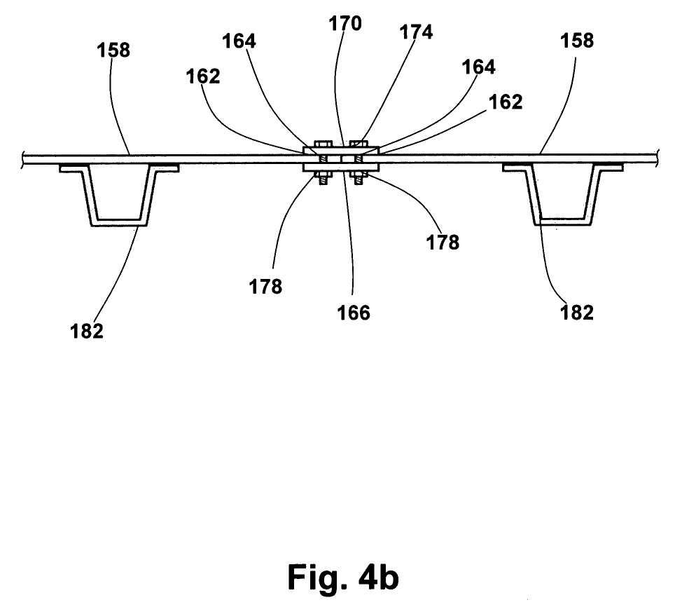

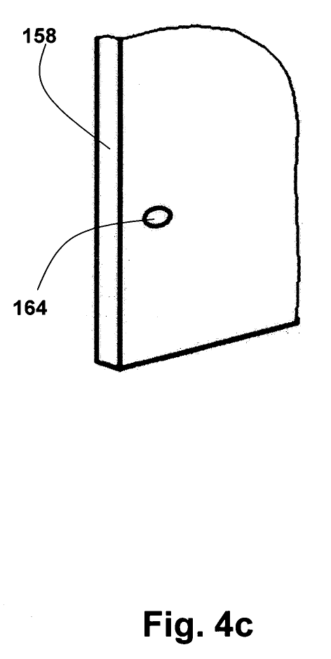

Turning to FIG. 6a, a side view of another ceiling according to the present invention is shown. The ceiling has been formed from a number of steel plates 246, 250, 254. The steel plates have bee joined at the edges using facing strips 258, 262 which are used in combination with bolts 266, 270 and nuts 274, 278 to hold the plates 246, 250, 254 firmly between the facing strips 258, 262 and the support members 282, 286. The ceiling has also been constructed with a floor surface for an upper level of the shoot house. The floor surface is made of panels 290, 294 which are placed on top of the ceiling panels and joints. The floor panels 290, 294 may be plywood, particle board, oriented strand board, ordinary construction floor sheeting, etc. so long as the material is sufficiently durable for use as a floor material. The floor sheeting 290, 294, while not strictly necessary, forms a smoother floor surface by covering the ridges made by the facing strips 258, 262 and bolts 266, 270, making the floor surface somewhat safer.

Additionally, sheets of a second material have been attached to the ceiling. The sheets 298, 302, 306 may be attached to the support members 274, 278 by bolts 310 and nuts 314, or by screws or any other suitable attachment method. The sheets 298, 302, 306 may be formed of sheetrock, ceiling tile, plywood, etc. The sheets provide an enhanced appearance to the ceiling as viewed from the shoot house beneath. More importantly, the sheets may be designed so as to provide a bullet containment area 318 in the ceiling to prevent bullets from striking the ceiling and ricocheting back towards people in the shoot house. Thus, plywood may be an ideal sheeting material as it is not overly damaged by a bullet and is strong enough to prevent bullets from exiting the containment area. Additionally, the floor sheeting may make the floor less slippery when wet.

Turning now to FIG. 6b, another side view of a ceiling according to the present invention is shown. The ceiling is similar to the ceiling of FIG. 6a, but includes additional floor support structure. The structure of FIG. 6b includes brackets 264 which may be formed as part of or simply attached to the facing strips 258, 262. The brackets 264 may be used to attach support rails 268, such as 2×4 lumber, which are used to support the floor panels 290, 294. The support rails 268 may run parallel to or transverse to the support members 282, 286. It is appreciated that the use of such support members may help in isolating the floor from the bullet proof plates. Additionally, if the support rails 168 are placed transverse to the support members 282, 286, the support rails may be spaced at different intervals than the support rails.

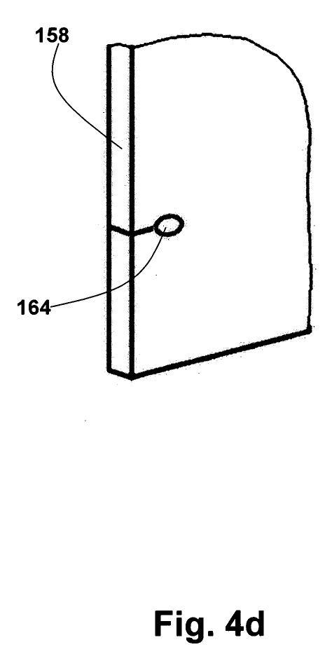

Turning now to FIG. 7, an end view of another ceiling according to the present invention. The ceiling, indicated generally at 322, is formed with a plurality of steel panels 326, 330, 334 which have been placed adjacent each other. The joints 338, 342 have been covered by the support members 346, 350. The support members 346, 350 have been formed as elongate square members. The panels have been attached to the support members using backing strips 354, 358 and a plurality of bolts 362, 366. The support member, facing strips, and plates are attached to form bullet proof joints. If a ceiling is formed as shown in FIG. 7 and a second floor is to be built above the ceiling, sheet material 370, such as plywood, may be placed on top of the support members 346, 350 such that a smooth surface is provided. If the ballistic ceiling is the uppermost surface on the complete structure, the sheet material 370 may be replaced by a roofing material of choice, or whatever material is necessary and suitable.

The strips and support members cover the joint between the panels and make it very unlikely that a bullet striking the joint would be able to pass through the joint. It will be appreciated from this figure that a large number of different ceiling configurations are possible with the present ceiling. As shown, the steel plates may be suspended from the support members. Additionally, the support members may have a variety of different shapes. In a preferred embodiment, the shapes may have a flat side for attachment to the steel panels.

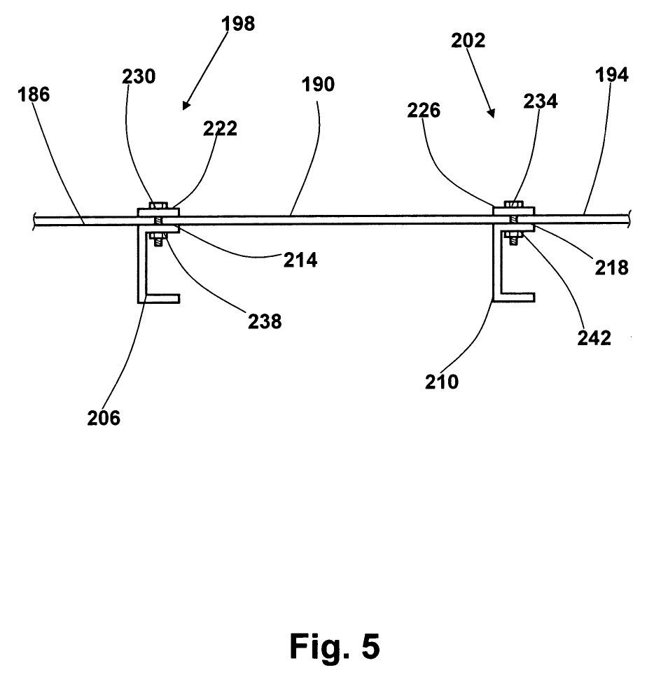

Turning now to FIGS. 8a-8f, a number of different shapes for support members are shown. The shapes shown are support member shapes according to a more preferred embodiment, and do not represent all of the shapes of support members which are suitable for use in the invention. The shapes include a box section 374, a C section 378, an L section 382, an I beam 386, and two channel shaped members 390 and 394. Of note, all of the shapes shown have at least one flat surface 398, 402, 406, 410, 414, 418, 422, 426, 430, 434, 438, 442, 446, which may be used to attach steel plates to form the ballistic ceiling, or to attach other materials, such as a bullet penetrable material as may be used to form a bullet containment chamber, and are thus a preferred embodiment, though other shapes may be used.

A shoot house which is formed according to the present invention should be sufficiently rigid and strong for most applications. While an open framework of facing strips and ceiling support members may be moved somewhat with relative ease, that same framework is quite stiff with the steel plate panels attached thereto. The steel plates prevent motion of the framework. As the shoot house is built by adding steel plates and either facing strips or ceiling support members in close succession, it is naturally rigid as it is being constructed. It is not, however, beyond the scope of the invention to use bracing members to further strengthen a shoot house where the size or particular configuration necessitates such bracing strips.

The bracing strips primarily prevent the shoot house from swaying side to side, front to back, or from twisting, as may be caused by wind, weather, moving objects within a shoot house, etc. Accordingly, the bracing strips may simply be strips of steel which attach to existing joints within the shoot house, such as facing strips, backing means, ceiling support members, etc. The bracing strips would typically be placed so as to connect two pieces, such as facing strips or ceiling support members, with the bracing strip being at an angle, preferably a 45 degree angle or close thereto, relative to the facing strips or support member. The bracing strip, when placed at an angle relative to the facing strip or support member, substantially inhibits movement of the facing strip or support member.

According to the present invention, multi-story shoot houses may be formed. A shoot house may be formed which has a modular ceiling attached at or near the top of the walls. As discussed, the ceiling members will substantially stiffen the shoot house and inhibit movement of the shoot house. A second story or shoot house level may be constructed on top of the ceiling. Accordingly, the ceiling members may form part of or support for a floor for the second level. The walls for the second level may be attached to the upper portion of the first level walls, or may be attached to ceiling joints. It will be appreciated that if a modular shoot house is formed with each wall panel being a consistent width, such as four feet, the ceiling panels are also in four foot increments and joints may be found every four feet. Thus, virtually any configuration is possible for the second floor of the shoot house as joints between wall and ceiling panels occur every four feet, in each possible location for joints between wall panels for the second floor.

Turning to FIG. 9a, a side view of a multi story shoot house is shown. A lower level wall has been formed with bullet proof wall panels 450, a backing strip 454 and facing strip 458 placed to cover the joint between adjacent wall panels, and bolts 462 placed to hold the facing strip, backing strip, and panels firmly together. A bracket 466 has been attached to the wall via facing strip 458 with bolts 470. It will be appreciated, however, that the bracket 466 may simply be welded to the facing strip 458, or may be formed integral to the facing strip. A support member 474 is attached to the bracket 466 and used to support ceiling panels 478 in a manner similar to that shown in FIG. 6. A backing strip 482 may be used to cover joints between ceiling panels if necessary. The ceiling panels have been bolted 486 to the support member 474. As shown, the ceiling forms a floor for a second level of a shoot house.

A bracket 490 has been attached to the ceiling with bolts 494, and used to support a second floor wall. The wall has been formed with bullet proof panels 498, a facing strip 502, and a backing strip 506 held together with bolts 510. The wall is attached to the bracket 490 via the facing strip 502 and is secured with bolts 514. Additionally, a plate or strip 518 may be attached to the walls and used to support the upper level wall alone or in combination with a bracket 490. A second bracket 522 has been attached to the ceiling via the backing strip 482, and has been bolted 526 to the support member 474. The bracket 522 has been used to attach a wall to the ceiling where there is not a lower level wall. The wall is formed with bullet proof panels 530, a facing strip 534, and a backing strip 538, and the facing strip and backing strip are held to the panels with bolts 542. The wall is bolted 546 to the bracket 522 via the facing strip 534.

Turning to FIG. 9b, a side view of a shoot house of the present invention is shown. The shoot house is similar to that of FIG. 9a and is numbered accordingly. One difference is that a space 516 has been formed between the lower wall (including steel plate 450, backing strip 454, and facing strip 458) and the ceiling (including the panels 478 and backing strips 482). The space 516 may be used to route electrical cables, target control cables, etc. between adjacent rooms of the shoot house. Such a space may also be used for ventilation in the shoot house if desired.

A strip or plate 518 may be used to bridge between the lower wall (including steel plate 450, backing strip 454, and facing strip 458) and the ceiling (including the panels 478 and backing strips 482) or an upper wall (including steel plates 498, facing strips 502, and backing strips 506). A plate 518 may be used which partially, substantially, or completely closes the space 516, or a strip may be used to provide a stronger joint. Thus, the shoot house may be formed with spaces 516 which are then closed if desired with plates 516 after installation of all necessary wires, control cables, etc. Substantially closing the space 516 would aid in containing bullets which might otherwise pass through the opening and exit the shoot house. It is appreciated that the areas adjacent the ceiling and floor of a shoot house often may pose increased risk of bullets passing around the ballistic walls, and often “no shoot zones” are designated for these areas.

While omitted for clarity, the walls and ceiling shown in FIGS. 9a and 9b may also be covered with a sheeting material similar to the wall of FIG. 1 and the ceiling of FIG. 6. The sheeting material is preferably a material which is penetrable by bullets but sufficiently durable to not be rapidly be broken down by the bullets. The sheeting material also should be sufficiently durable to not allow a bullet which has passed through the sheeting and ricocheted off of the bullet proof panel to again pass through the sheeting and exit the wall. It is also preferable to space the sheeting apart from the bullet proof panels. The sheeting would thus form a bullet containment area and would make the shoot house significantly safer by substantially eliminating the risk of being hit by a ricocheting bullet. Plywood has been found to be an optimal material for covering the walls and ceiling. Sheeting material may also be placed on top of the ceiling to make a smoother floor for the second shoot house level. The sheeting may cover any backing strips, bolts, or the like which protrude from the ceiling.

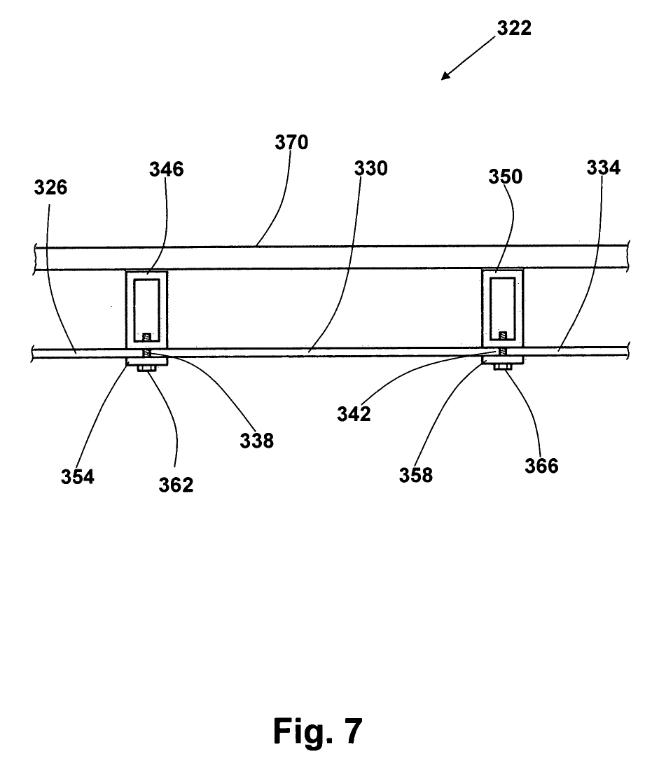

It is appreciated that FIG. 9a and FIG. 9b show assembled portions of a shoot house according to the present invention. It is not possible to show each of the structures without making these drawings confusing. Accordingly, wall joints, brackets, bullet containment chambers, etc. have been omitted for clarity in showing the assembled structure. As such, it is appreciated that FIGS. 9a and 9b encompass and include the attachment details of FIG. 2, the brackets of FIGS. 3a through 3e, the joint details shown in FIGS. 4a, 4b, 5, 6a, 6b, and 7, the plate details shown in FIGS. 4c and 4d, the bullet containment structures and floor structures of FIGS. 6a, 6b, and 7, the beams of FIGS. 8a-8f, and the joint details of FIG. 10. These structures are all shown individually for clarity in discussing the various substructures of the invention, but are all part of the whole invention embodied in a modular shoot house, as detailed in FIGS. 9a and 9b.

FIGS. 9a and 9b show, in cross section, the general joint structure of a modular shoot house according to the present invention. It is appreciated that the specific shape and configuration of the brackets, joiner strips, pieces or plates, etc. may vary according to the use of the joint in the shoot house structure. Thus, different brackets and different resulting joint structures may be necessary where a ceiling support member is parallel to or perpendicular to a wall, or where the ceiling support member is placed above a wall or abutting into a wall. Thus, FIGS. 10 through 18 show details of the bracket shapes and resulting joint structures which accomplish various joints required in constructing a modular shoot house. As such, the joints and structures shown in FIGS. 10 through 18 are considered as part of FIGS. 9a and 9b, being variations of the joint structures based on particular location or application within the resulting shoot house.

Turning now to FIG. 10, a front view of upper and lower bullet proof walls as used in a modular shoot house of to the present invention is shown. A lower wall has been formed with bullet proof panels 550 and facing strips 554 covering the joints between panels 550. An upper wall has been similarly formed with bullet proof panels 558 and facing strips 562. It will be appreciated that often a joint 566 will exist between upper wall panels 558 and lower wall panels 550. To further strengthen the shoot house, the joint 566 may be covered with a facing strip 570 which is attached to the wall panels 550, 558 by bolts 574. A backing means such as a backing strip, washer, or the like, may be placed on the opposite side of the joint 566 and held to the joint with the bolts 574. Alternatively, the joint 566 may be strengthened by smaller joint plates 578 which are attached to the wall panels 550, 558 by bolts 582. Additionally, the joint 566 may simply be strengthened by a plurality of bolts 586 and washers 590, having washers and nuts placed on the opposite side of the joint 566. As the joint 566 will typically be covered by the lower level ceiling/upper level floor or will be very near the floor in an area unlikely to be struck by a bullet, it may not be necessary to cover the entire joint 566 with a joint strip 570. It may, however, be desirable to use a simple fastener such as bolts 586 and washers 590 to further attach the upper panels 558 to the lower panels 550 and thereby brace the panels.

It will be appreciated that in building a shoot house according to the present invention, it is desirable to cover the joints between wall and ceiling panels with a continuous strip of metal. Thus, facing strips have been shown covering the wall joints and ceiling joints. It is also possible to cover the ceiling joints with a flat surface of a support member, as has been shown. Once the joint has been covered by a metal strip, it is not necessary, though it is desirable, to cover the side of the joint opposite the facing strip or support member with a continuous metal strip. Washers or other similarly sized objects are sufficient to secure the bolts and facing strips to the joints, providing an increased support surface for attaching the bolts. Backing means may not be necessary in all situations. It will also be appreciated that whenever bolts are used in this application to fasten objects together, the bolts may be inserted into threaded holes in the appropriate location, or may simply be attached and tightened with nuts. Screws, rivets, welding, or other fastening methods are also equally applicable and within the scope of the invention.

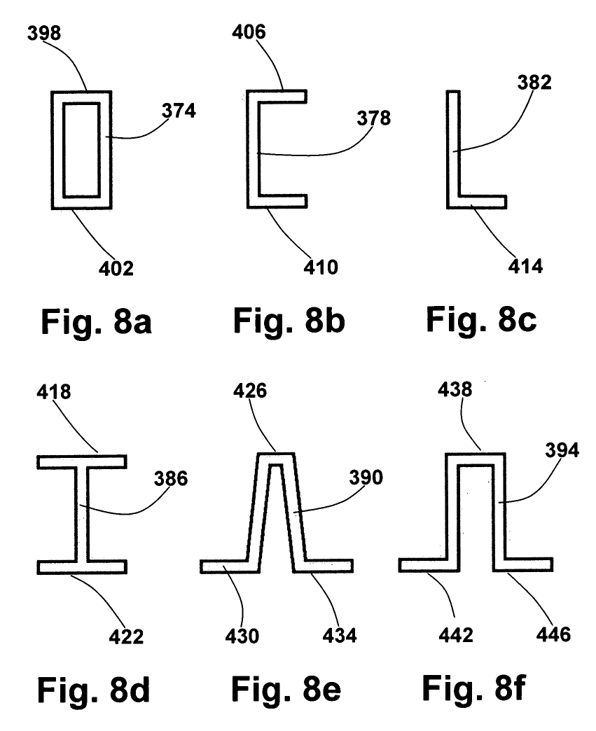

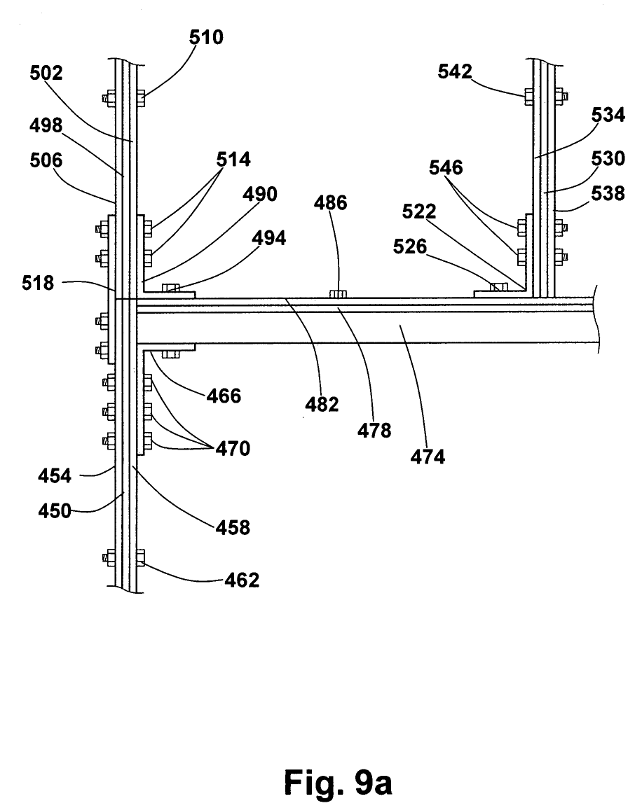

Turning now to FIG. 11a a front view of a bracket of the present invention is shown. The bracket 610 is configured to attach a horizontal support member as may be used in a ceiling to a shoot house wall. The bracket therefore has holes 614 formed therein for attachment to the wall, such as by bolting to the facing strip or to the joint between wall plates. The bracket 610 also includes a flange 618 which is disposed perpendicular to the body of the bracket and which is used to attach the ceiling support member to the bracket.

FIG. 11b shows a side view of the bracket of FIG. 11a. The side view of the bracket 610 more clearly shows the flange 618 and the holes 622 formed in the flange which are used to bolt or otherwise attach the bracket to the ceiling support member. It will be appreciated that the flange 618 may be formed integrally to the bracket, such as by bending a flat plate into a bracket with perpendicular flange. Alternatively, the flange may be a separate plate which is welded or otherwise attached to the bracket.

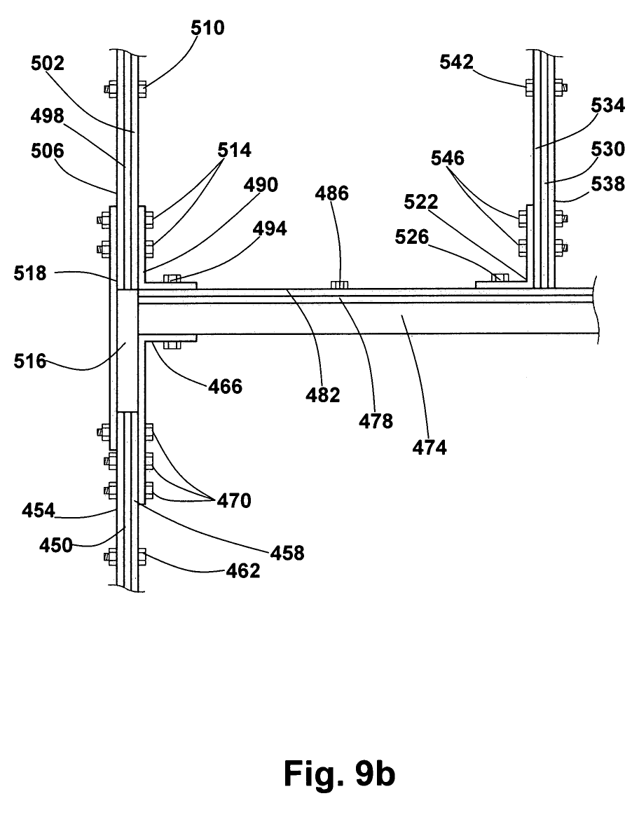

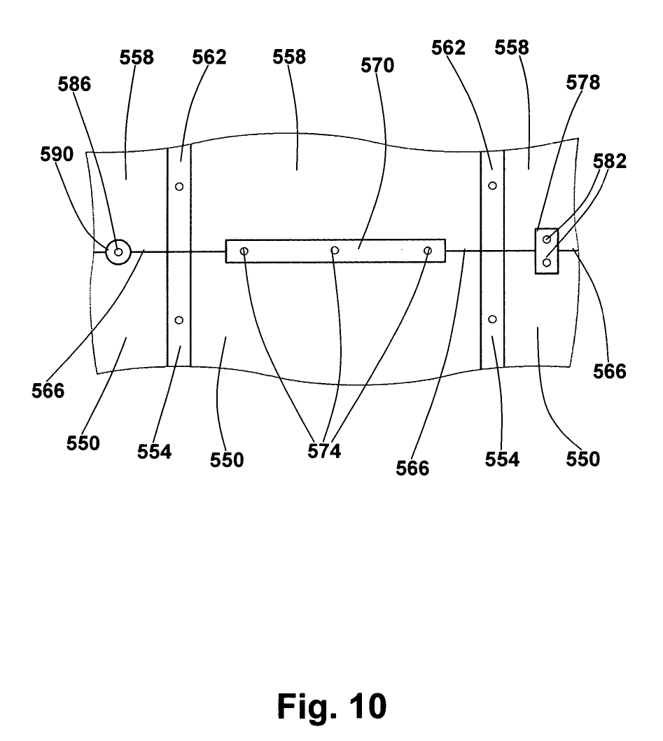

Turning now to FIG. 12a, a front view of another bracket of the present invention is shown. The bracket 626 is configured to attach a ceiling support member to a wall where the support member is parallel to the wall. As such, the bracket has a first flange 630 which is attached to the wall and a second flange 634 which is attached to the support member.

FIG. 12b more clearly shows the first flange 630 and second flange 634. It is again appreciated that the first flange 630 and second flange 634 may be formed as part of the bracket 626, such as being cut from flat sheet and bent into place, or may be welded or attached to the bracket. Holes 638 are formed in the first flange 630 and used to attach the flange to the wall, such as by attachment to a facing strip or to the joint. Similarly, holes may be formed in the second flange 634 and used to attach the bracket to the ceiling support member.

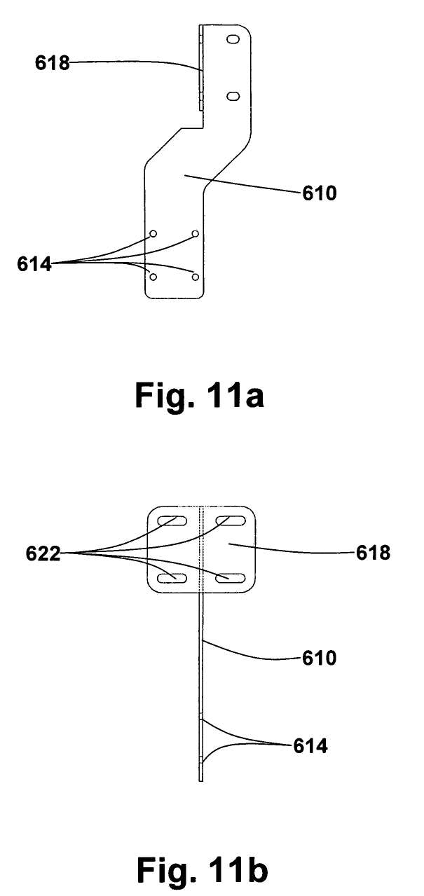

Turning now to FIG. 13, a joint of a shoot house incorporating the bracket of FIGS. 11a and 11b is shown. The bracket 610 is attached, with fasteners 654 such as bolts, to a joint (indicated generally at 650) formed between two plates 652, 656. The joint 650 is typically formed with a facing strip 658 as has been discussed. For clarity, many of the structures such as facing or backing strips, bolts, bullet containment chambers, sheeting, flooring, etc. are removed from the joints shown in FIGS. 13, 14, 17, and 18. The joints are shown without such structures to allow for greater clarity in viewing the brackets and methods of attaching wall panels and joints to ceiling support members and ceiling panels. The ceiling panels may not be shown, but are attached according to the methods shown.

The bracket 610 is typically bolted to a ceiling support member 662 via flange 618. The ceiling support member 662 is used to support the ceiling structure, shown generally at 666. The ceiling structure 666 is as has been discussed and may include ballistic panels and joints, as well as support rails and flooring sheets such as plywood or subflooring. Another wall section (indicated at 670) may be attached to the ceiling structure 666 as has been shown, such as in FIG. 9a.

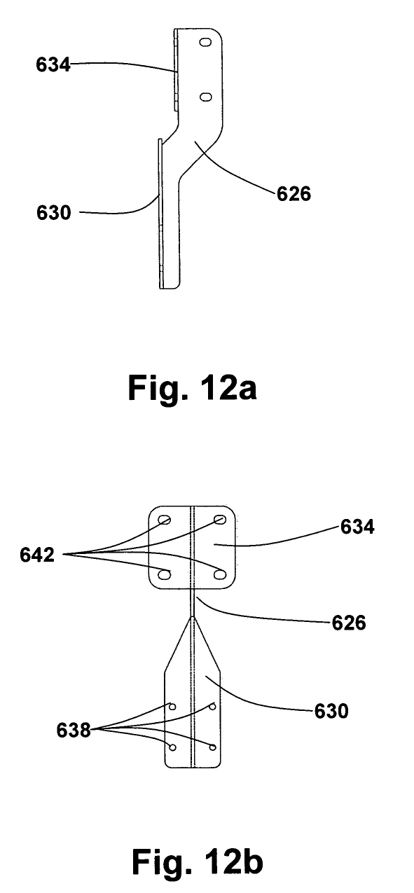

Turning now to FIG. 14, a joint of a shoot house of the present invention is shown. The joint utilizes the bracket of FIGS. 12a and 12b. As has been discussed, the bracket 626 is configured for mounting a ceiling support member 678 parallel to a wall 682. The wall 682 is formed with steel panels 686 joined with a facing strip 690 as has been discussed. The bracket 626 is attached to the wall 682 by bolting the first flange 630 to the joint, and to the ceiling support member 678 by bolting the second flange 634 to the ceiling support member. A ceiling/floor 694 may be attached to the ceiling support member 678, and may possibly include bullet proof panels, bullet containment chambers, floor beams and sheeting, etc. as has been discussed. An upper wall 698 may be attached to the ceiling support member 678 or to the floor/ceiling 694 as has been previously shown and discussed, such as in FIG. 9a or 9b.

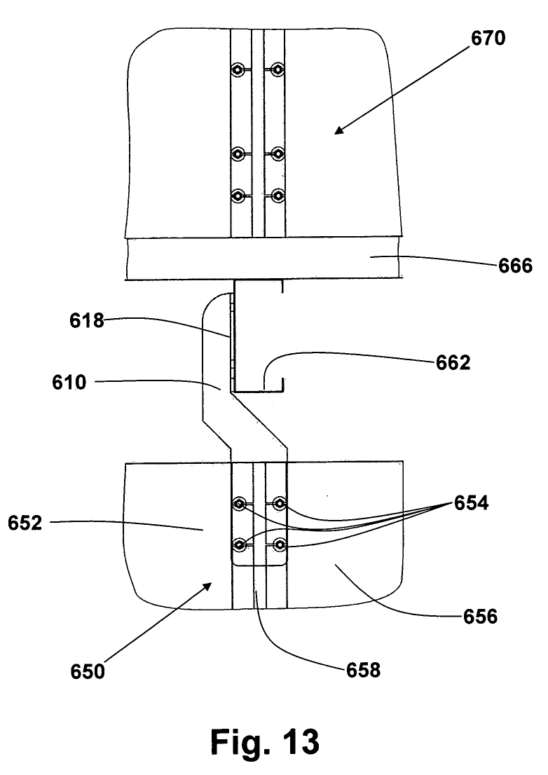

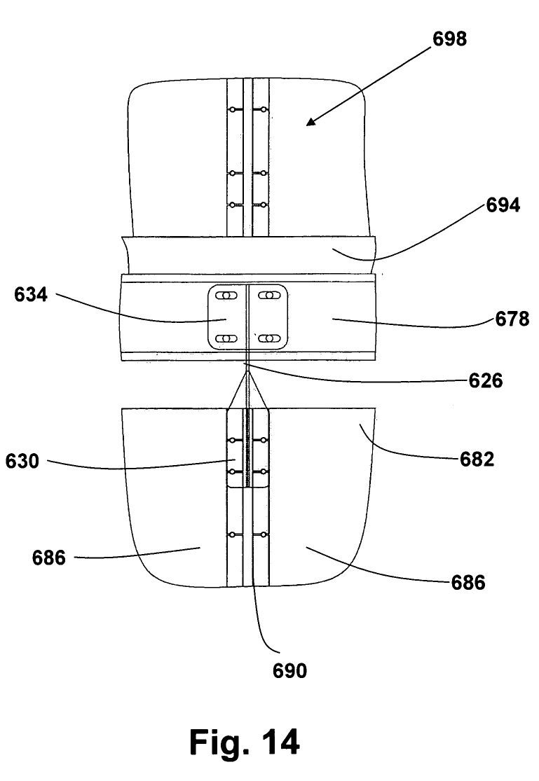

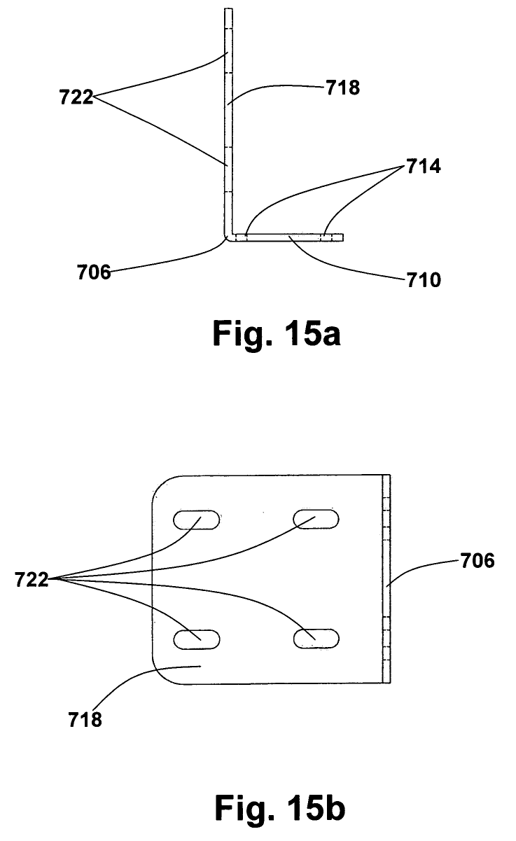

Turning now to FIG. 15a, a top view of another bracket of the present invention is shown. The bracket 706 is configured for attaching a support member such as the ceiling support members discussed to a wall where the support member is perpendicular to the wall and extends from a wall rather than being disposed above the wall. The bracket 706 includes a first flange 710 having holes 714 which is configured for attachment to a wall, such as by bolting to a joint between wall panels. The bracket 706 also includes a second flange 718 having holes 722 which is configured for attachment to a support member.

FIG. 15b shows a side view of the bracket of FIG. 15a, better illustrating the second flange 718 and holes 722. FIG. 15c shows an end view of the bracket of FIG. 15a, and better illustrates the first flange 710 and holes 714. In discussing this and all other brackets, it is appreciated that the number and location of holes as well as the configuration of the bracket may be adjusted according to the mounting location of the bracket, weight carried by the bracket, etc.

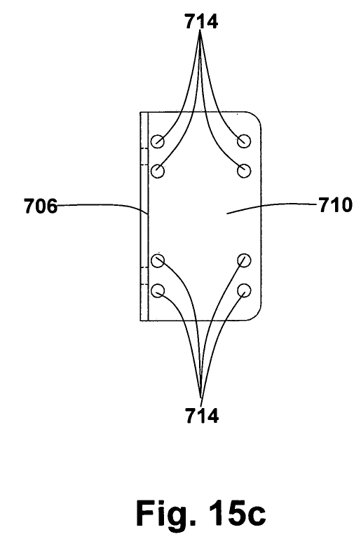

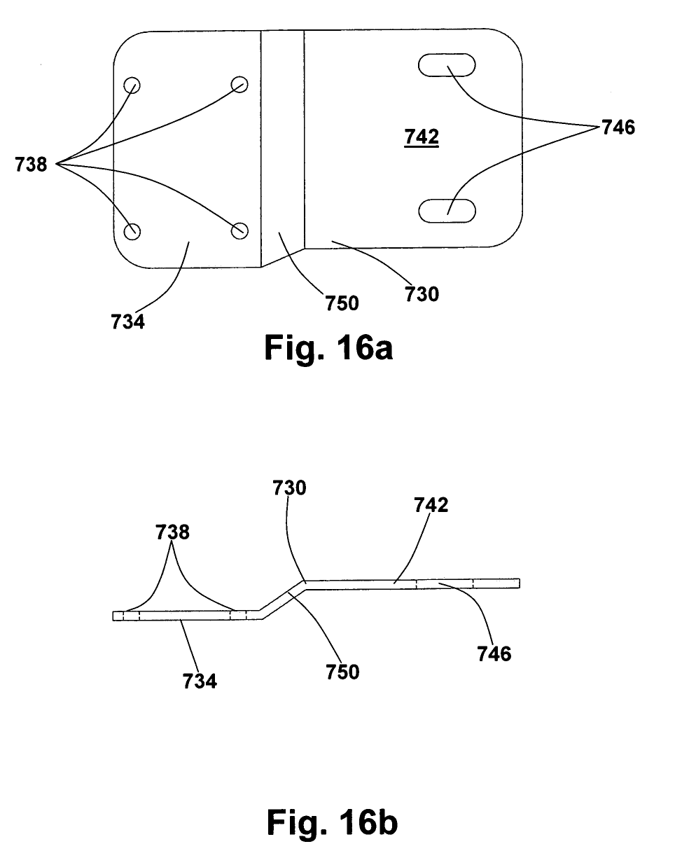

Turning now to FIG. 16a, a side view of a bracket of the present invention is shown. Then bracket 730 is configured for attaching a support member to a wall where the support member is generally parallel to the wall and extends from the wall instead of being above the wall. The bracket 730 has a first flange 734 having holes 738 which attaches to a wall, such as to a joint or facing strip. The bracket also has a second flange 742 with holes 746 which may be attached to a support member. As can more clearly be seen in FIG. 16b, the bracket 730 may have a center section 750 which connects the first flange 734 and second flange 742 in a zigzag shape. Such a center flange 750 offsets the first flange 734 and second flange 742 from each other, allowing for easier attachment of the bracket to both a wall and support member.

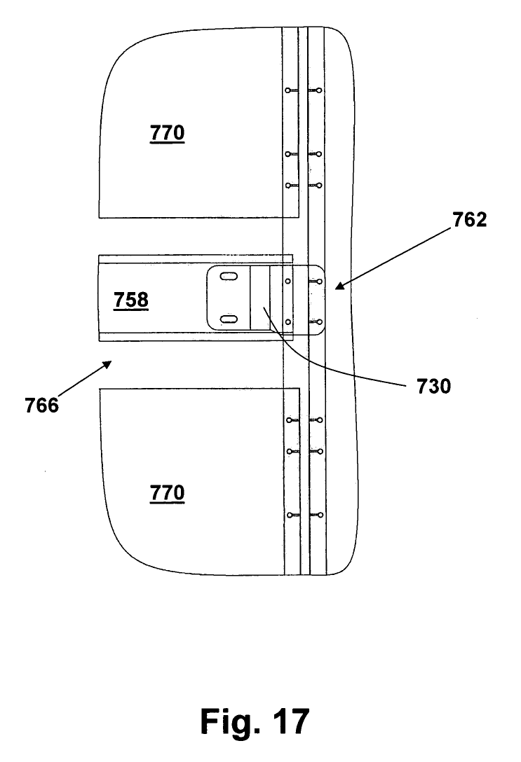

Turning now to FIG. 17, a joint of a shoot house incorporating the bracket of FIGS. 16a and 16b is shown. The bracket 730 is shown attaching a support member 758 to a wall joint, indicated at 762. The wall structure and joint 762 are formed as has been shown and discussed previously. It will be appreciated that a space 766 may formed between the plates 770 adjacent the bracket 730 and support member 758, or no space may be present. Attaching a support member parallel to a wall as shown may allow for the installation of stairs, etc. in the shoot house.

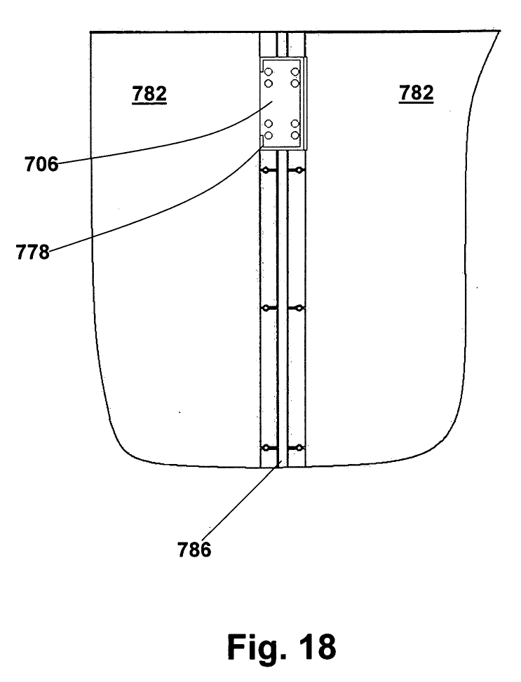

Turning now to FIG. 18, a joint of a shoot house using the bracket of FIGS. 15a through 15c is shown. The bracket 706 has been used to attach a support member 778 to a wall. The support member 778 extends perpendicularly from the wall. The wall includes steel panels 782 joined by a facing strip 786 as has been previously discussed. The bracket 706 has been bolted to the joint, but may be welded or otherwise attached.

It is appreciated that the various structures and assemblies of the shoot house which have been discussed are each small parts of the invention, which may require a combination of these structures to form a completed shoot house. Various structures of the shoot house, such as ceilings, floors, stairs, etc. will each require different types of brackets, or combinations of the brackets and joints shown.

There is thus disclosed an improved method for forming shoot houses. It will be appreciated that numerous modifications may be made to the present invention without departing from the scope of the invention. The preceding examples are illustrative of the invention, and do not define the scope of the invention.

What is claimed is:

1. A method for forming a section of a modular bullet proof ceiling comprising:
placing a support member in a generally horizontal orientation, the support member having a surface which is flat and generally horizontal;
placing two bullet proof plates in a generally horizontal orientation such that an edge of the first plate is adjacent an edge of the second plate so as to form a joint and such that the joint is placed on top of the flat surface of the support member;
placing a backing means on top of the joint; and
holding the support member, steel plates, and backing means firmly together.

2. The method of claim 1 wherein the method further comprises disposing a bracket on a wall to thereby support the ceiling.

3. The method of claim 2, wherein the support member is attached to the bracket.

4. The method of claim 2, further comprising two support brackets attached to two walls, and wherein each end of the support member is attached to a bracket.

5. The method of claim 1, wherein the method further comprises attaching the support member, steel plates, and backing means with a plurality of bolts to thereby hold the support member, steel plates, and backing means firmly together.

6. The method of claim 1, wherein the method further comprises selecting a backing means from the group consisting of washers and steel strips.

7. The method of claim 1, wherein the method further comprises attaching a sheet material to the bottom of the support member to thereby form a bullet containment chamber.

8. The method of claim 1, wherein the method further comprises attaching a sheet material to the to of the ceiling.

9. The method of claim 1, wherein the facing strip of a joint forms a support column for holding up the ceiling.

10. A method for forming a bullet proof ceiling, comprising:
placing a plurality of support members in a generally horizontal fashion, each of the support members having at least one flat and generally horizontal surface;
disposing a plurality of bullet proof plates adjacent the support members to thereby form a ceiling, the plates being oriented such that the edge of a plate is adjacent the edge of any adjacent plate so as to form a joint and such that the joint is disposed adjacent the flat and generally horizontal surface of the support member; and
attaching the plurality of bullet proof plates to the plurality of support members.

11. The method of claim 10, wherein the method further comprises attaching a plurality of brackets to at least two walls and attaching the plurality of support members to the plurality of brackets.

12. The method of claim 10, wherein the bullet proof plates are releasably attached to the support members.

13. The method of claim 10, wherein the bullet proof plates are attached to the support members with a plurality of bolts.

14. The method of claim 10, wherein the method further comprises disposing a backing means to cover the side of the joint opposite the support member and attaching the backing means to the joint.

15. The method of claim 10, wherein the method further comprises disposing at least one sheet of bullet penetrable material to the ceiling.

16. The method of claim 10, wherein the method further comprises attaching the ceiling to a modular bullet proof wall, the bullet proof wall comprising at least two bullet proof panels, the panels being arranged such that an edge of one panel is disposed adjacent the edge of another panel to form a joint, and wherein the joint is covered by a facing strip.

17. The method of claim 16, wherein the method further comprises attaching at least one bracket to the wall and attaching the ceiling to the at least one bracket.

18. The method of claim 16, wherein the facing strip is held firmly against the bullet proof panels with a plurality of bolts.

19. The method of claim 16, wherein the wall further comprises a backing means disposed to cover the joint on the side of the joint opposite the facing strip.

20. The method of claim 16, wherein the backing means is selected from the group consisting of a steel strip and washers.

21. A bullet proof ceiling comprising:
a plurality of bullet proof plates disposed horizontally so as to form a ceiling, adjacent plates having their adjacent edges placed in a linear arrangement so as to form a joint;
a plurality of elongate support members, the support members having at least one flat surface and being disposed either above or below the plates such that the at least one flat surface of the support members covers the joint between the bullet proof plates, the support members being attached to the plates.

22. The bullet proof ceiling of claim 21, further comprising a backing means placed to cover the joint on the side opposite the support members, the backing means being attached to the plates.

23. The bullet proof ceiling of claim 21, wherein the support members are releasably attached to the plurality of bullet proof steel plates.

24. The bullet proof ceiling of claim 21, further comprising a plurality of brackets which are attached to the support members and configured for supporting then weight of the ceiling.

25. The bullet proof ceiling of claim 21, further comprising a sheet of bullet penetrable material disposed below the ceiling, spaced apart from the ceiling, and attached to the ceiling to thereby form a bullet containment chamber.

26. The bullet proof ceiling of claim 21, further comprising a sheet of material disposed above the ceiling and attached to the ceiling.

27. A shoot house comprising the bullet proof ceiling of claim 15 and at least one modular ballistic wall, the wall comprising at least two bullet proof panels placed adjacent each other such that the edges of the panels form a joint, a facing strip placed to cover the joint, and a backing means placed to cover the joint on the side opposite the facing strip.

28. The shoot house of claim 27, further comprising a plurality of bolts for holding the facing strip and backing means tightly against the panels.

29. The shoot house of claim 27, wherein the backing means are selected from the group consisting of strip steel and washers.

30. The shoot house of claim 27, wherein the panels are bullet proof steel plates.

31. The shoot house of claim 27, wherein the shoot house further comprises at least one bracket attached to the walls and configured for supporting the ceiling.

32. The shoot house of claim 31, wherein the brackets are attached to the facing strips.

33. The shoot house of claim 31, wherein the brackets are attached to the ceiling support members.

34. A modular bullet proof ceiling comprising:
at least one bracket;
at least one elongate support member disposed in a generally horizontal manner and being attached to the at least one bracket, the support member having at least one flat and generally horizontal surface;
at least two bullet proof plates, the plates being disposed in a generally horizontal manner such that an edge of the first plate is disposed adjacent an edge of the second plate to form a joint, and the plates being disposed such that the joint is placed adjacent the at least one flat surface of the support member to thereby be covered by the flat surface;
a backing means disposed adjacent the joint on the side of the joint opposite the support member; and
an attachment means for holding the backing means, steel plates, and support member firmly together.

35. The ceiling of claim 34, wherein the at least one elongate support member is releasably attached to the at least one bracket.

36. The ceiling of claim 34, wherein the attachment means comprises a plurality of bolts.

37. The ceiling of claim 34, wherein the backing means is selected from the group consisting of washers and steel strips having holes formed therein.

38. The ceiling of claim 34, further comprising a sheet of bullet penetrable material disposed below the ceiling, spaced apart from the steel plates, and attached to the ceiling to thereby form a bullet containment chamber.

39. A bullet proof ceiling comprising:
at least two bullet proof plates disposed horizontally so as to form a ceiling, the plates being oriented such that an edge of the first plate is disposed adjacent the edge of a second plate to form a joint;
a facing means disposed to cover the joint;
a backing means disposed on the side of then joint opposite the facing means to thereby cover the joint;
attachment means configured for holding the facing means, at least two bullet proof plates, and backing means firmly together; and
a plurality of elongate support members disposed to support the ceiling.

40. The ceiling of claim 39, wherein each of the support members has at least one flat surface and wherein the flat surface forms the facing means disposed to cover the joint.

41. The ceiling of claim 39, wherein the facing means, backing means, and bullet proof plates are releasably held together by a plurality of bolts.

42. The ceiling of claim 39, wherein the backing means are selected from the group consisting of washers and steel strips having a plurality of holes formed therein.

43. The ceiling of claim 39, further comprising a sheet of bullet penetrable material disposed below the ceiling, spaced apart from the ceiling, and attached to the ceiling to thereby form a bullet containment chamber to prevent bullets from ricocheting off of the ceiling.

44. A shoot house comprising the ceiling of claim 39 and further comprising at least one bullet proof wall, the wall comprising:
at least two bullet proof panels, the panels being oriented such that an edge of one panels is adjacent the edge of another panel so as to form a joint;
a facing strip placed adjacent the joint so as to cover the joint;
a backing means placed to cover the joint on the side of the joint opposite the facing strip; and
a plurality of bolts for holding the facing strip and backing means tightly against the panels.

45. A shoot house comprising:
a plurality of bullet proof walls;
a plurality of brackets attached to the plurality of walls and configured for supporting a ceiling;
a plurality of support members attached to the plurality of brackets;
at least two steel plates disposed horizontally to form a ceiling, the plates being disposed so that an edge of the first plate is disposed adjacent the edge of the second plate to thereby form a joint;
a facing means disposed to cover the joint; and
attachment means for holding the facing means tightly against the joint.

46. The shoot house of claim 45, wherein the brackets are releasably attached to the bullet proof walls.

47. The shoot house of claim 45, wherein the plurality of support members each have at least one flat edge and wherein the at least one flat edge is the facing means disposed to cover the joint.

48. The shoot house of claim 45, further comprising a backing means selected from the group consisting of washers and steel strips with holes formed therein, the backing means being disposed on the side of the joint opposite the facing means to thereby cover the joint and being held tightly against the joint by the attachment means.

49. The shoot house of claim 45, further comprising a sheet of bullet penetrable material disposed below the ceiling, spaced apart from the steel plates, and attached to the ceiling to form a bullet containment chamber.

50. The shoot house of claim 45, further comprising a second floor, the second floor comprising a plurality of bullet proof walls configured to form rooms, the second floor resting upon at least one of the first floor walls and first floor ceiling.

51. The shoot house of claim 50, further comprising a second floor ceiling.

52. The shoot house of claim 51, wherein the ceiling is formed of at least two steel plates, the plates being disposed generally horizontally such that an edge of the first plate is disposed adjacent an edge of the second plate to form a joint, the joint being covered by a facing means and backing means, the backing means and facing means being held firmly against the joint, and the ceiling further comprising at least one elongate support member attached to the steel plates to thereby support the ceiling.

53. The shoot house of claim 50, wherein the second floor walls are attached to at least one of the first floor walls and the first floor ceiling with a plurality of brackets.

54. The method of claim 16, wherein the method further comprises attaching at least one upper story bullet proof wall on top of at least one of the ceiling or modular bullet proof wall.

55. The method of claim 54, wherein the upper story bullet proof wall is formed with a plurality of bullet proof panels disposed adjacent each other to form a joint and a plurality of facing strips disposed to cover the joint and attached to the plurality of bullet proof panels.

56. The shoot house of claim 27, wherein the shoot house comprises at least two modular ballistic walls and at least two shoot house levels, and wherein at least one wall is a lower level wall and at least one wall is an upper level wall.

57. The shoot house of claim 56, wherein the ceiling is attached to the lower level wall with brackets and wherein the upper level wall is attached to at least one of the lower level wall and ceiling.

58. The shoot house of claim 44, wherein the at least one bullet proof wall is a lower level wall, the ceiling being attached to the lower level wall, and wherein the shoot house further comprises at least one upper level wall forming a second level of the shoot house.

59. The shoot house of claim 58, wherein the at least one upper level wall further comprises:
at least two bullet proof plates, the plates being disposed such that an edge of one plate is adjacent the edge of another plate so as to form a joint; and
a facing strip disposed to cover the joint and attached to the at least two bullet proof plates.

60. A shoot house comprising:
a lower level wall comprising a first and second bullet proof plates disposed such that an edge of the first plate is adjacent the edge of the second plate forming a joint, and a facing strip disposed to cover the joint and being attached to the first and second plates, the facing strip further comprising a bracket disposed on an end of the facing strip;
a ceiling comprising a support member attached to the bracket and at least one bullet proof plate attached to the support member.

61. The shoot house of claim 60, further comprising a second level wall disposed above the first level wall and ceiling, the second level wall comprising a first and second bullet proof plates disposed such that an edge of the first plate is adjacent the edge of the second plate forming a joint, and a facing strip disposed to cover the joint and being attached to the first and second plates
